(19) United States
(12) Patent Application Publication
(10) Pub. No.: US 2017/0282104 A1
(43) Pub. Date: Oct. 5, 2017

(54) FLUID FILTER WITH OPTICAL KEY AND MANIFOLD WITH OPTICAL LOCK

(71) Applicant: 3M INNOVATIVE PROPERTIES COMPANY, St. Paul, MN (US)

(72) Inventors: Scott A. Baum, Hudson, WI (US); Jeremy A. Schmoll, Pine Island, MN (US); Michael E. Griffin, Maplewood, MN (US); David A. Ender, New Richmond, WI (US); Robert E. Astle, Middlefield, CT (US); Justin M. Mazzoni, Cheshire, CT (US)

(73) Assignee: 3M INNOVATIVE PROPERTIES COMPANY, St. Paul, MN (US)

(21) Appl. No.: 15/510,539

(22) PCT Filed: Nov. 9, 2015
(86) PCT No.: PCT/US15/59655

§ 371 Date: Mar. 10, 2017

Related U.S. Application Data
(60) Provisional application No. 62/077,663, filed on Nov. 10, 2014.

(51) Int. Cl. B01D 35/30; C02F 1/00; B01D 35/147; B01D 37/04; B01D 35/14

(52) U.S. Cl. CPC B01D 35/305; B01D 37/04; B01D 35/14; B01D 35/147; C02F 1/001; B01D 2201/291; B01D 2201/4015; B01D 2201/4053; B01D 2201/4061; C02F 2201/004

(57) ABSTRACT

Keyed fluid-handling devices comprise a fluid-handling device such as a filter, a bypass, or an adapter and an optical key. The optical keys are amenable to all types of filter component and can be readily retrofitted to existing designs. The optical keys may be formed from a variety of materials and combination of phases. That is, optical keys may comprise one or more solid materials, or perhaps may result from a combination of: solid materials, such as in transparent or semi-transparent polymers or glass; liquid fluids, such as water; and gaseous gaps such as an air gap. Optical keys may be light conduits or light guides. Filter manifolds comprise optical locks to ensure compatibility of the filter components.

### TECHNICAL FIELD

This disclosure relates to the field of fluid treatment, and more particularly to the field of fluid filters and manifolds and filtration systems using such filters. The filters, operatively mate and/or seal to the manifolds to provide, for example, filtered water in household appliances such as refrigerators.

### BACKGROUND

Exemplary water filter systems with filter cartridges that operatively mate and/or seal to manifolds are provided in, for example, U.S. Pat. Nos. 5,753,107; 6,027,644; and 6,193,884 (Magnusson), which are incorporated herein by reference. These particular systems and filter cartridges permit cartridge changes without drainage at the input and output ports. The manifolds provide a bayonet fitting to mate with a recessed port of the filter cartridges.

Other filter assemblies that disclose cartridges having a body portion and a neck portion are provided in, for example, U.S. Pat. No. 6,458,269 (Bassett), which is incorporated herein by reference, where a keyed lockout system to determine replacement cartridge compatibility is provided using either axially projecting teeth, radially projecting teeth, or combinations thereof are provided.

U.S. Patent Application Pub. No. 2006/0151364 discloses a filter cartridge including, mounted thereon, a communication/sensor circuit completion unit including a reflector mounted on a filter assembly operably positioned so that it will complete a signal circuit only when the filter cartridge is properly mounted, for use.

### SUMMARY

For safety and compatibility purposes, it is useful to design fluid filter cartridges, herein also referred to simply as filters, that are keyed to corresponding manifolds such that an improper filter is not placed into service in an application for which it is not intended. The improper filter may not be designed to remove the impurities within the fluid, or it may be incompatible with the fluid to be processed. For such applications, and from a consumer's perspective, such keying technology provides the benefit of authentication and authenticity. In other words, the user or consumer is protected by this technology by virtue of being assured that only a compatible cartridge, which may be approved by NSF for claimed specified reductions in various impurities, will be authenticated for use in the application.

The keyed lockout system of U.S. Pat. No. 6,458,269 is mechanical, relying on physical features of the filter cartridge and corresponding manifold to complete the system. Under such circumstances, for each different manifold design, a different filter cartridge design is needed, requiring individualized designs and tooling.

This leads to significant costs and complexities. As such, an optical keying system that could utilize or standardize on a single mechanical interconnect while still providing the keying functionality would be a significant advantage.

The signal circuit of U.S. 2006/0151364 relies on a reflector as the communication/signal circuit completion unit for a replaceable filter element located in a housing, which is not suitable for all types of filters; especially, for disposable filter cartridges having a filter element encased within a sealed housing and often having a cylindrical neck portion for use in the tight confines of a refrigerator water manifold. Furthermore, the reflector does not provide a keying function in that any filter having the reflector will work, or even a filter not having the reflector will work if the user adds a simple reflector to the end of a generic filter. Additionally, as best seen in FIG. 6 of U.S. 2006/0151364, light enters the reflector 41 after leaving fiber optic 36, travels in a straight line through the air to the reflector surface, is reflected at a 90 degree angle, travels in a straight line through the air to the opposite side of the reflector surface is reflected at a 90 degree angle, and then travels again in a straight line through the air to optic fiber 39 for transmission to the signal receiver. No portion of the light's travel within the filter is non-linear (after leaving the fiber optic 36 in the manifold and until reentering optic fiber 39 in the manifold). An optical key having the ability to transmit the light along a non-linear, arcuate, or curved path as a portion of its travel within the filter would enable the optical key to be compatible with many more filters; especially, filters already possessing a cylindrical body or neck geometry.

Optical keys can be formed from a variety of materials and combination of phases. That is, optical keys may comprise one or more solid materials, or perhaps may result from a combination of: solid materials, such as in transparent or semi-transparent polymers or glass; liquid fluids, such as water; and gaseous gaps such as an air gap. The optical keys can be adapted to existing filter designs requiring no changes to already-existing mechanical interconnects. The optical keys may also be incorporated in various ways into new filter designs. Optical locks that coordinate with the optical keys can be installed in already-installed manifolds to provide reverse compatibility. The optical locks may also be incorporated in various ways into new manifold designs. This provides a significant advantage for a manufacturer already having a large installed user base, but looking to provide new functionality, and only wanting to provide a single replacement filter that fits the new and old manifolds.

Fluid-handling devices are used to receive water or fluid from a source such as a water manifold. Exemplary fluid-handling devices include but are not limited to: filters or filter cartridges, bypasses (also referred to as bypass caps), and adapters, each of which is configured to communicate with the water or fluid source. Water or fluid passes into and out of fluid-handling devices, which may or may not provide treatment and/or purification to the water or fluid. Water or fluid exiting a fluid-handling device is then routed as appropriate. From a filter, water or fluid may be routed back to the manifold in treated or unpurified form. From a bypass, water or fluid may be routed back to the manifold in untreated or unpurified form. From an adapter, water or fluid may be routed into a filter. Filters are made of one or more filter elements or components, which include but are not limited to, filter media, end caps, and housings. Disclosed herein are fluid-handling devices and filter components that have an optical key, which is amenable to all types of water/fluid treatment systems, manifolds, filter cartridges and can be readily retrofitted to existing designs.

In a first aspect, a keyed fluid-handling device comprises: a fluid-handling device; and an optical key associated with a portion of the fluid-handling device, the optical key providing a non-linear path for light. The fluid-handling device may comprise a filter, a bypass, or an adapter, which is engagable with a water manifold. The fluid-handling device may comprise an inlet opening defined by a portion of the device.

In an embodiment, the fluid-handling device comprises a filter that comprises: a filter media; and optionally: an end cap affixed to the filter media, a housing enclosing the filter media, or both; wherein the optical key attached to a portion of the filter media or to a portion of the optional end cap or housing. The optical key may comprise a light conduit that is arcuate. The optical key may comprise glass, a thermoset plastic, a thermoplastic, or combinations of materials. The optical key may comprise one or more polymers selected from the group consisting of: polyvinylidenefluoride (PVDF), poly(methyl methacrylate) (PMMA), poly-fluoroalkyl methacrylates, urethanes, and polycarbonate. The optical key comprises a transparent filter cap that comprises a body, an input face, and an output face.

In another aspect, a fluid filter cartridge comprises: a filter media; a housing enclosing the filter media, the housing having inlet and outlet openings in fluid communication with the filter media; and a light guide that is attached to a portion of the filter cartridge. The light guide may be attached to the housing. The light guide may be attached to a neck portion of the housing. The light guide may comprise a glass or a polymer selected from the group consisting of: polyvinylidenefluoride (PVDF), poly(methyl methacrylate) (PMMA), poly-fluoroalkyl methacrylates, urethanes, and polycarbonate. The light guide may comprise one or more light extraction elements. The light guide may comprise an arcuate shape. The light guide may comprise an input face and an output face. The input face, the output face, or both may comprise a surface having a face angle θ in the range of 1° to 90°, or 5° to 85°, or 10° to 80°, or 15° to 75°, or 20° to 70°, or 25° to 65°, or 30° to 60°, or 35° to 55°, or 40° to 50°. A refractive index of the light guide may be from 1.30 to 1.75, or 1.35 to 1.45, or 1.45 to 1.55, or 1.55 to 1.65.

The light guide may comprise an arch. The arch may span 150-210 degrees and may comprise two or more light extraction elements along the arch. In a detailed embodiment, the light extraction elements are approximately evenly spaced. A specific embodiment provides that the arch spans 180 degrees. A specific embodiment is a light guide further comprising three light extraction elements: a first light extraction element in a first 60 degree portion, a second light extraction element in a second 60 degree portion, and a third light extraction element in a third 60 degree portion.

Another aspect provides a fluid filter manifold comprising: a manifold body; a manifold inlet port and a manifold outlet port; a fluid supply valve; and an optical lock located on the manifold body comprising a light source and a light sensor. The fluid supply valve may be operatively connected to the optical lock that comprises: a first state wherein the light sensor detects light from the source; and a second state wherein the light sensor does not detect light from the light source.

In one or more embodiments, the light sensor cannot detect light from the light source unless an optical key is present to deliver the light from the light source to the light sensor.

The manifold body may comprise: a frame; one or more braces connected to the frame; an inlet boss comprising a first face and a first outer diameter about a longitudinal axis; a first annular seal circumscribing the inlet boss; a discharge opening in fluid communication with the manifold inlet port located in the first face; and an outlet cylindrical projection depending from the inlet boss comprising a second face and a second outer diameter about the longitudinal axis, the second outer diameter being is smaller than the first outer diameter of the inlet boss; a second annular seal circumscribing the outlet cylindrical projection and an outlet opening in fluid communication with the manifold outlet port located in the second face.

The light source may be is located on a first brace and the light sensor is located on a second brace. The light source may be located 180 degrees away from the light sensor.

A further aspect is a water treatment system comprising: the fluid filter manifold according to any embodiment herein; and a keyed fluid-handling device comprising a fluid-handling device and an optical key.

Another further aspect is a water treatment system comprising: a keyed fluid-handling device of any embodiment disclosed herein or a fluid filter cartridge of any embodiment disclosed herein; and a fluid filter manifold comprising an optical lock.

In an aspect, a method of treating water comprises: obtaining a fluid filter manifold of any embodiment disclosed herein; operatively connecting a fluid filter element comprising an optical key to the fluid filter manifold; and supplying water to the fluid filter manifold.

In another aspect, a method of treating water comprises: obtaining a keyed fluid-handling device of any embodiment disclosed herein or a fluid filter cartridge of any embodiment disclosed herein; operatively connecting the fluid filter element or the fluid filter cartridge to a fluid filter manifold comprising an optical lock to the fluid filter manifold; and supplying water to the fluid filter manifold.

These and other aspects of the invention are described in the detailed description below. In no event should the above summary be construed as a limitation on the claimed subject matter.

### BRIEF DESCRIPTION OF THE DRAWINGS

The disclosure may be more completely understood in consideration of the following detailed description of various embodiments of the disclosure in connection with the accompanying drawings, in which:

FIGS. 1A and 1B provide schematics of exemplary light guides in relation to a light source and one or more light sensors;

FIGS. 2A and 2B provide schematics of the light guide at a first orientation and at a 180 degree rotation to the first orientation;

FIGS. 3A, 3B, and 3C provide schematics of exemplary light guides with light extraction elements at varying locations;

FIG. 4 provides a plot of light intensity ratio as a function of refractive index of the light guide obtained from ray tracing simulations;

FIG. 5 is an electrical schematic for implementing control by light intensity ratio;

FIGS. 6A, 6B, and 6C are schematics of an exemplary filter elements comprising an optical key;

FIG. 7 is a schematic of an exemplary filter manifold comprising an optical lock;

FIG. 8 shows a schematic of the filter element of FIG. 6 partially rotated into the manifold of FIG. 7;

FIG. 9 shows a schematic of the filter element of FIG. 6 fully installed into the manifold of FIG. 7 to complete an optical circuit;

FIG. 10 shows a cross-section of an exemplary filter;

FIG. 11 shows a cross-section of an exemplary adapter comprising an optical key;

FIG. 12 is a schematic view of the exemplary adapter of FIG. 11 and a manifold in an expanded view;

FIG. 13 is a schematic view of an exemplary bypass;

FIG. 14 is a schematic view of the bypass of FIG. 13 and a manifold in an expanded view;

FIG. 15 is a schematic view of an exemplary filter element comprising an optical key;

FIG. 16 is a cross-section view of the exemplary filter element of FIG. 15 in a housing; and

FIG. 17 is a perspective view of an exemplary filter cartridge.

### DETAILED DESCRIPTION

Provided are filter components: filter media, adapters, and housings having optical keys. Manifolds and systems for use with the same are also provided. Optical keys are achieved with one or more materials or phases that provide a non-linear path for light. For example, light conduits and/or light guides may be attached to replaceable components of filter systems such as filter media, filter adapters, and/or filter housings. Generally, a light source and a light sensor are provided in a filter manifold to form an optical lock. Upon installation of a filter component, the path between the light source and sensor of the manifold is blocked or not completed. An optical key, provided in conjunction with the filter component, provides an optical connection to route the light source to the sensor. Once the sensor receives the light from the source, a solenoid may be activated to open a water valve or the control logic can provide another control function.

Filter components having an optical key compatible with the corresponding optical lock of the manifold will permit the system to function properly. For example, the optical key can sense when the filter is fully installed and then the control logic can activate the water supply to the filter eliminating the need for mechanical ramps on the filter and poppet valves in manifold. Filter components without the optical key would block or not complete the path between the light source and sensor, therefore, preventing the water from being supplied. One or more light sensors can be located in the manifold such that the only light available to activate the sensor(s) is delivered by a light conduit or a light guide.

Optical keys may be readily designed into new cartridge designs due to their versatility of material and form. Optical keys may also be retrofitted into existing filter cartridge designs. As indicated, filters are often cylindrical, thus having an optical key that can route light along a non-linear path is advantageous. Optical keys, in some embodiments, are designed to perform identically within the system upon a 180 degree rotation of the filter providing installation symmetry.

The following terms shall have, for the purposes of this application, the respective meanings set forth below.

An “optical key” is a device used to deliver light in order to complete an optical circuit with an optical lock. Optical keys can be formed from a variety of materials and combination of phases.

An “optical lock” is a combination of a light source and a light sensor, where the light sensor detects the light source upon insertion of an optical key.

A “light conduit” is a device that may be hollow or solid, formed of one or more materials that propagate light between two points.

A “light guide” is a shaped, transparent or semi-transparent solid material that propagates light between two points using the process of internal reflection. The reflection can be accomplished either through a reflective coating or total internal reflection.

A “filter cartridge” or “filter” comprises a filter media for purifying and/or treating fluid disposed in a housing.

A “housing” for the filter comprises a body or sump that is sealed at one end by a cover (also referred to as a filter cap or a cartridge cap) or by an end cap attached to a filter media.

“Filter media” is a material located in a filter used to purify and/or treat a fluid. The media may provide functionalities including, but not limited to, mechanical filtration, ion exchange, and/or adsorptive capacity. One or more structures, such as end caps, may be associated or attached with the media to direct flow of fluid to be processed through the media and out of the cartridge. In some instances, there is a core or other passage internal to the filter media for fluid flow.

By “end cap” it is meant a substantially solid piece of material placed at the end of a filter media such as a media block, which is dimensioned so as to at least seal the greater portion of the surface area of one or both ends of the filter. In some embodiments, the end cap may have a port or an opening to allow fluid flow into or from a core of the filter. End caps on either end of a media cartridge may independently have additional features to facilitate installation and/or use of the media within a body or sump of a housing.

“Filtered fluid” and “filtered water” refer to fluid and water that have contacted the filter media element to achieve a desired purity or treatment.

“Fluid communication” refers to the ability of a fluid to flow between two points including in the presence of valves that may be opened and closed.

Reference to “operatively connected” means that movement or operation of an item is dependent on another item to which it is operatively connected.

Reference to “attached” means that there is a connection between a first item, such as the optical key and another item, for example, a filter component. The connection may be permanent as a result of integral formation by, for example, injection molding the two items at the same time, or by affixed formation by, for example, overmolding the first item to the second item, or even by permanent affixing using glue or epoxy. Or the connection may be removable by, for example, a snap-fit or a lightly adhesive connection, between two separately fabricated items. One aspect of the optical keys is that they may be removable in order to retrofit them to existing filters.

Reference to an optical key being “associated with” a portion of the fluid-handling device includes optical keys that may be structures that are independent of the functions of the fluid-handling device and those structures that may also provide functions of the fluid-handling device.

### Optical Keys

Optical keys can be formed from a variety of materials and combination of phases. That is, optical keys may comprise one or more solid materials, or perhaps may result from a combination of: solid materials, such as in transparent or semi-transparent polymers or glass; liquid fluids, such as water; and gaseous gaps such as an air gap.

An exemplary optical key is a light conduit that may be a solid or hollow material that propagates light between two points. Light conduits are formed in any suitable shape to accommodate varying filter designs. In one or more embodiments, the light conduit is arcuate, meaning at least one portion is curved such that light may be delivered through a curved or non-linear path. In this way, arcuate light conduits differ from mirrors or light pipes that deliver light only in a linear path.

Another exemplary optical key is a light guide is made from a shaped, transparent or semi-transparent solid material that propagates light between two points using the process of internal reflection, which can be accomplished either through total internal reflection of the material itself or by way of a reflective coating provided by a cladding material. Thus, light guides may be “unclad” or “clad”. The light guide is “solid,” which distinguishes it from an air guide (pure reflection) or a light pipe having a hollow interior that propagates light through an air cavity made up of internal highly reflective sidewalls. Light guides generally have one or more input faces and one or more output faces. A light guide is different from a mirror that reflects light through the air and the mirror is not easily adaptable to varying shapes such as those presented by filter elements and housings. Exemplary light guides may be in any suitable form or material that is compatible with fluid filter elements and housings and fluids sought to be filtered. Exemplary light guides are found in U.S. Pat. No. 5,432,876 (Appeldorn), which is incorporated herein by reference. Exemplary forms include but are not limited to those that are amenable to various shapes and sizes, for example: fibers, injection-molded pieces, films, having shapes as plates or slabs, with varying cross sections and the like. The light guide may be formed or molded, for example, into an arcuate shape to match a water filter's shape, which is advantageous for adapting to a variety of designs. In addition, light guides may comprise light extraction elements, for example notches or protrusions, to deliver light at various locations as desired.

Suitable materials for light guides include, but are not limited to glass, thermoset plastics, and thermoplastics resulting in transparent or semi-transparent materials. Exemplary polymers include but are not limited to: polyvinylidenefluoride (PVDF) having a refractive index (RI) of ˜1.41; poly(methyl methacrylate) (PMMA) having a RI of 1.50; polycarbonate having a RI of 1.59; polyheptafluorobutyl methacrylate having a refractive index of 1.38 or other poly-fluoroalkyl methacrylates. The refractive index of the material itself may be included in the optical key design such that if the material is not the correct refractive index, the filter will not authenticate. In some embodiments, the refractive index of the light guide may be from 1.30 to 1.75, or from 1.35 to 1.45, or from 1.45 to 1.55, or from 1.55 to 1.65. Choosing a specific refractive index used in combination with a ratio of the light guide's output, when using a specific end geometry for the light guide, can distinguish the refractive index of the light guide material and that can be used to authentic that the filter cartridge is appropriate for use in the intended application. Filters can be provided with light guides of various refractive index materials that can be detected by the system as appropriate or not for the intended application.

Other possible design choices for the light guides are to make them wavelength-specific. For example, a combination of dyes may be used create a narrowed wavelength filter. The dye could also be selected to fluoresce and/or to enhance a particular wavelength. In this way, the sensor could detect the presence or absence of a particular wavelength or light characteristic(s). If detected, then the water filter is qualified; if not detected, then the water filter is disqualified.

A light guide may be provided by incorporating one or more input faces and one or more output faces in a filter element or component. For example, a transparent cover of a filter housing may be designed with an input face and an output face to control light and serve as a light guide.

### Optical Lock

The optical lock comprises a light source and a light sensor. Typically, the optical lock is located in the system manifold that receives a filter media optionally with a housing, the optical key being provided with the media or housing. In addition, it is contemplated that permanent filter housings may also have an optical lock for use with replaceable filter media having an optical key. The light source is any compatible device that readily fits into the manifold. Suitable light sources include but are not limited to: light-emitting diodes (LEDs), fluorescent light bulbs, and incandescent light bulbs. Light sensors are those known in the art, for applications such as ambient light sensing in automobiles and laptop computers. These sensors are typically silicon photo-transistors found in a variety of packaging styles. It is common for these sensors to use optical filters to mimic the human eye optical response or to suppress infrared radiation. In one or more embodiments, an ambient light sensor from the TEMT 6200 series by Vishay is coupled to the light emitted from a Luxeon Z-ES 4000K neutral white LED through the light guide.

In the manifold, the light source is located such that upon installation of a compatible filter component, the light enters the light guide, travels therethrough, and exits the light guide to arrive at one or more light sensors. Design variations include using slightly different light source locations and varying numbers of sensors on different manifolds with specific output geometry on the light guide that will activate all of the light sensors as needed. That is, the light guide is a “key” that may deliver light into multiple point locations, where by design, sensors are present to authenticate the filter. As such, a multitude of optical keys can be designed that may have the same nominal exterior geometry but have notches, protrusions, or outlets at various locations along the length of the light guide to direct light out of the light guide at a specific location. See, for example, FIGS. 3B and 3C. The optical key concept is similar to a mechanical key having the same nominal geometry but teeth ground to different heights at different locations along the length of the key to activate the appropriate pins in the lock.

The material the optical key is made of, as measured for example by refractive index (RI), permits a further design variable. Light intensity delivered by the optical key, for example, is a function of the optical key material and the geometry of the optical key where the light exits. The use of two or more light sensors to receive light from two or more locations on the optical key allows the creation of a ratio of the light intensities, which is a parameter that may be used for authentication.

In order for the optical lock to function, the light source is in an “on” mode, where light is emitted from the light source. The light source may be operated continuously for certain time periods depending on the application. In addition, the light source may be operated intermittently to be in an “on” mode for specified periods of time and in an “off” mode otherwise where no light is emitted from the light source.

### Filter Media

Filter media is material that is housed by filters herein. Suitable types of filter media include but are not limited to those that provide purification (e.g., separation of impurities from a fluid) and those that provide treatment to a fluid (e.g., adjust hardness, disinfect, and the like) and combinations thereof Media that may be used individually or in any combination are provided in the following.

The media may be materials called adsorbents that an ability to adsorb particles via different adsorptive mechanisms. Adsorption is a surface phenomenon, where atoms or ions adhere to a surface of an adsorbent. The media may be in the form of, for example, spherical pellets, rods, fibers, molded particles, or monoliths with hydrodynamic diameter between about 0.01 to 10 mm. If such media is porous, this attribute results in a higher exposed surface area and higher adsorptive capacity. The adsorbents may have combination of micropore and macropore structure enabling rapid transport of the particles and low flow resistance. Adsorbent particles may be selected from the group consisting of activated carbon, diatomaceous earth, ion exchange resin, metal ion exchange sorbent, activated alumina, antimicrobial compound, acid gas adsorbent, arsenic reduction material, iodinated resin, and combinations thereof.

The media may be particles contained loosely or particles formed into a media block. Exemplary particles for use as media include, but are not limited to: activated carbon, polymeric binder, diatomaceous earth, and ion exchange resin. For example, media comprising activated carbon and polymeric binder particles may form a carbon-based filter block. Fluid contacting a carbon-based media, for example, may achieve a reduction in sediment, chlorine, and lead. Fluid contacting a weak acid cation (WAC) exchange resin may achieve a reduction in hardness. Ion-exchange resin may be provided alone or located in a core of a filter block. A nonwoven material may be wrapped around a filter block.

Some suitable media may include cellulosic media, synthetic media, or a combination thereof. In addition, media may include structures, pleated or unpleated, including, but not limited to: a woven structure, a non-woven structure, a microporous membrane or composite, a monolith, a melt-blown fiber (MBF) structure, a hollow-fiber membrane, and an open-cell foam. Exemplary materials of construction of these structure may include, but are not limited to: nylon (e.g., nylon 6,6), ethylene chlorotrifluoroethylene (ECTFE), polypropylene, polyethylene, polyvinylidene fluoride (PVDF), polyethersulfone, polysulfone, polyester, polytetrafluoroethylene (PTFE), polycarbonate, nitrocellulose, cellulose acetate, cellulose, or combinations thereof.

### Uses

In general terms, the optical key of a fluid-handling device unlocks the optical lock of a manifold. The optical key may be associated with any portion of device used to receive water or fluid from a source such as a water manifold. Generally, fluid-handling devices include but are not limited to: filters or filter cartridges, bypasses, and adapters, each of which is configured to communicate with the water or fluid source. With specific regard to filters, the optical key may be anywhere on a replaceable or reusable filter component, such as a filter media, an end cap and/or the housing including a body or sump and/or a cover.

Certain filter media are amenable to having an optical key such as a light conduit or light guide attached directly thereto. For example, pleated filters and filtration membranes are replaceable components of filer systems having permanent housings. With an optical lock being in the permanent housing that in turn provides a communication to the manifold, the optical key may be used to provide authentication that the proper media is being used.

Other filter media, such as a carbon block with or without polymeric binder particles, that typically have a filter or end cap can incorporate the optical key into the filter cap, which can be shaped as needed to readily fit to the filter's geometry. A light conduit or light guide may be attached integrally with the filter cap, during injection molding for example, or it may be attached after the filter cap is made.

Housings for filter media may also include a light conduit or a light guide. For example, the body or sump of a housing may have the light conduit or guide, which is illuminated by a light source. The light conduit or guide can then route the light up the sump and along a cover of the filter cartridge to a sensor in the interior of the manifold. The cover itself may be formed of transparent or semi-transparent material and input and output faces are associated therewith to serve as a light guide.

Also, the light conduit or guide could be used to illuminate the exterior of the filter housing in a pleasing way. It could be used to signal the need for a filter change by changing the illumination of the exterior from one color (for example, blue or green to indicate that water quality is good) to orange to red as the filter media is used up. The light change could be controlled by a timer reset upon a new filter installation or by a flow meter in the water supply.

Before describing several exemplary embodiments of the invention, it is to be understood that the invention is not limited to the details of construction or process steps set forth in the following description. The invention is capable of other embodiments and of being practiced or being carried out in various ways.

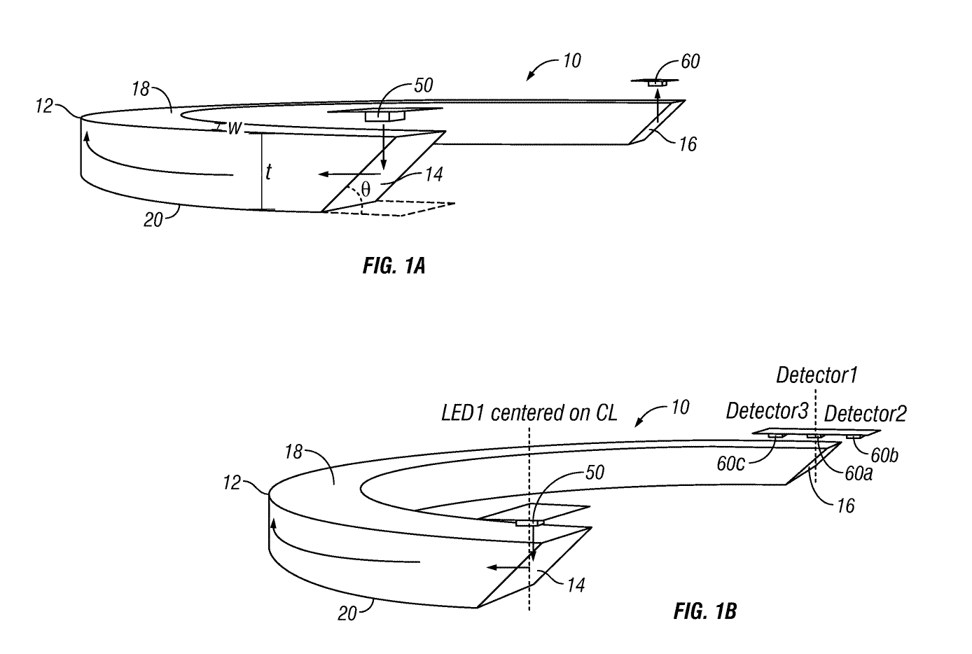

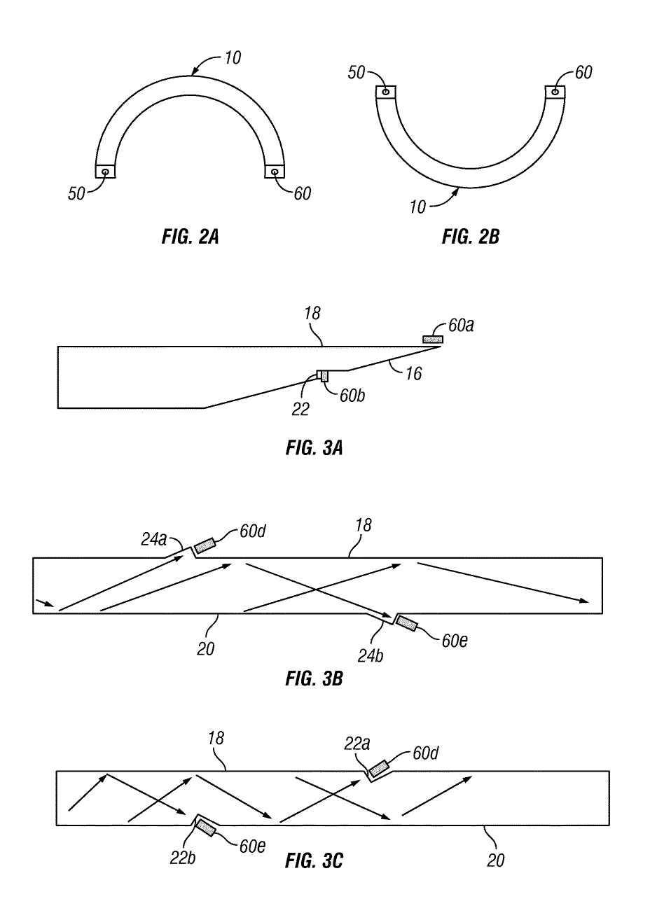

Turning to the figures, FIGS. 1A and 1B provide schematics of exemplary light guides in relation to a light source and one or more light sensors. FIGS. 2A and 2B provide schematics of the light guide at a first orientation and at a 180 degree rotation to the first orientation. In FIGS. 1A and 1B, light guide 10 has an arcuate shape 12, an input face 14, and output face 16. As shown in FIG. 1A, the light guide 10 has a thickness, t, between a first/top surface 18 and a second/bottom surface 20 and a width, w, of the first/top surface 18 and the second/bottom surface 20. Angle Theta, θ, which may be referred to as a “face angle” is defined by the intersection of one of the faces 14 or 16 with an extended plane of the second/bottom surface 20. In FIGS. 1A and 1B, Thetas for both the input face 14 and the output face 16 are approximately 45°. It is not necessary to angle the input and output faces, but so doing is one way for determination of a ratio of the light emitted by the light guide that can distinguish the refractive index of the light guide material as light exits the light guide at different locations. The angle Theta for the input or output faces can vary. In some embodiments the angle Theta is less than 90 degrees, or in the range of 1° to 90°, or 5° to 85°, or 10° to 80°, or 15° to 75°, or 20° to 70°, or 25° to 65°, or 30° to 60°, or 35° to 55°, or 40° to 50°.

In other embodiments, the light guide may comprise an annulus, which is a structure in a ring-shape. The light guide may comprise all or a portion of a circle, a semi-circular, an ellipse shape spanning any distance or degree, i.e., 10-360 degrees that is suitable for the application.

Light source 50 may be an LED located on a circuit board located on a body of a manifold (not shown) and centered directly above the 45 degree input face 14 of the light guide 10. Light is directed into the light guide 10 through input face 14, and the light at output face 16 of the light guide 10 is collected by one or more detectors 60 placed directly above that end's 45 degree face. The arrows show the non-linear path the light takes through the light guide. Light detector(s) 60 are also located on a circuit board on the body of the manifold. In FIG. 1A, light exiting through the first/top surface 18 is detected by the light sensor 60. In FIG. 1B, light exiting through the first/top surface 18 and out of output face 16 are detected by light sensors 60a and 60b, respectively. Light sensor 60c is provided to accommodate installation symmetry. With respect to FIGS. 2A and 2B, with either 180 degree orientation of light guide 10, the configurations of light sources and sensors of FIGS. 1A and 1B will work properly as optical locks. That is, rotation of the light guide 10 by 180 degrees about its central axis just exchanges the input end with the output end, with no change in authentication of the light guide attached to the filter. In the embodiments of FIGS. 2A and 2B, the light source is located 180 degrees away from the light sensor. The light guide may be a shape, for example, an arch, that spans 180 degrees, thereby comprising three 60 degree portions. Additional light extraction elements, such as from 1 to 10 additional extraction elements, as shown in FIGS. 3B and 3C may be located at various positions along the arcuate light guide to direct light out of the light guide and into corresponding detectors to create different optical keys. In one or more embodiments, a first light extraction element may reside in a first 60 degree portion, a second light extraction element may reside in a second 60 degree portion, and a third light extraction element may reside in a third 60 degree portion. Such embodiments may be configured for installation symmetry. Corresponding sensors are then located in or on the manifold.

Further with respect to FIG. 1B, detector 60b (and likewise detector 60c) are located on an extension of the circuit board holding detector 60a. The ratio of the light received from detector 60a to that received by detector 60b is sensitive to the refractive index of the light guide material. Tuning the refractive index provides a way to set the ratio within certain bounds, which can be analyzed by comparator circuitry. The refractive index of the light guide, and how to achieve it, adds a design parameter to further add to the safety and security of an overall water filtration system.

FIGS. 3A, 3B, and 3C provide schematics of exemplary light guides with light extraction elements at varying locations. In FIG. 3A, a portion of an exemplary light guide is shown with output face 16 comprising an exemplary light extraction element in the form of a notch 22 that directs light to sensor 60b. Light through the first/top surface 18 is detected by the light sensor 60a. FIG. 3B shows a portion of an exemplary light guide comprising exemplary light extraction elements in the form of protrusions, where a first protrusion 24a protrudes from the first/top surface 18 that directs light to sensor 60d and a second protrusion 24b protrudes from the second/bottom surface 20 that directs light to sensor 60e. The arrows indicate movement of light within the light guide. FIG. 3C shows a portion of an exemplary light guide comprising exemplary light extraction elements in the form of notches, where a first notch 22a protrudes from the first/top surface 18 that directs light to sensor 60d and a second peak 22b protrudes from the second/bottom surface 20 that directs light to sensor 60e. The arrows indicate movement of light within the light guide. Thus, the optical key can direct light out one or more sides in addition to the ends to further vary the combinations and permeations for making an optical key that is only compatible with one optical lock installed in the manifold.

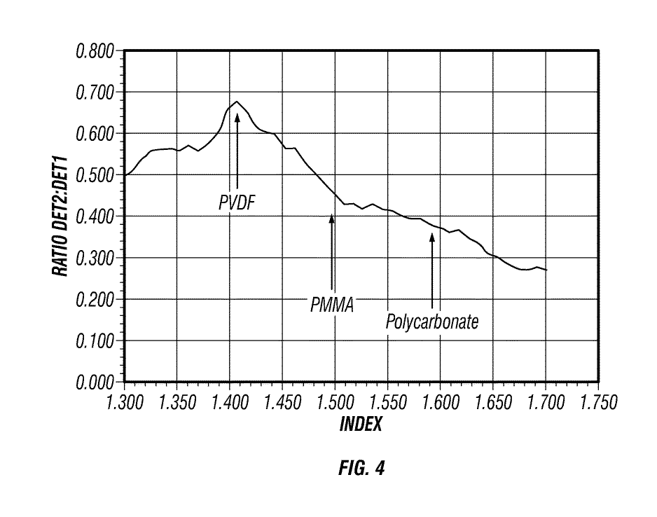

FIG. 4 provides a plot of the ratio as a function of refractive index of the light guide obtained from ray tracing simulations for the configuration shown in FIG. 1B. Exemplary materials for light guides are PVDF, PMMA, and polycarbonate which have their refractive indices indicated by arrows on the plot. Choosing a material with a refractive index of ˜1.41 gives a ratio of approximately 0.67 as indicated by the PVDF arrow in the figure. Different materials for the light guide provided in the same geometry will have different ratios, which provides a preliminary optical key such that only the specific material with the correct ratio detection will work to authentic the optical key attached to the filter. In the simulation, the light guide housing is designed as absorbing to avoid stray light scattered onto the detector. To enable improved results when authenticating, it may be desirable to control the stray light scattering that may permit artificial achievement of the correct ratio. Methods to control stray light could entail using a flat black coloration for selected portions of the filter, housing, or manifold or utilizing light baffles or shades to block light from entering into specific locations within the optical lock in the manifold.

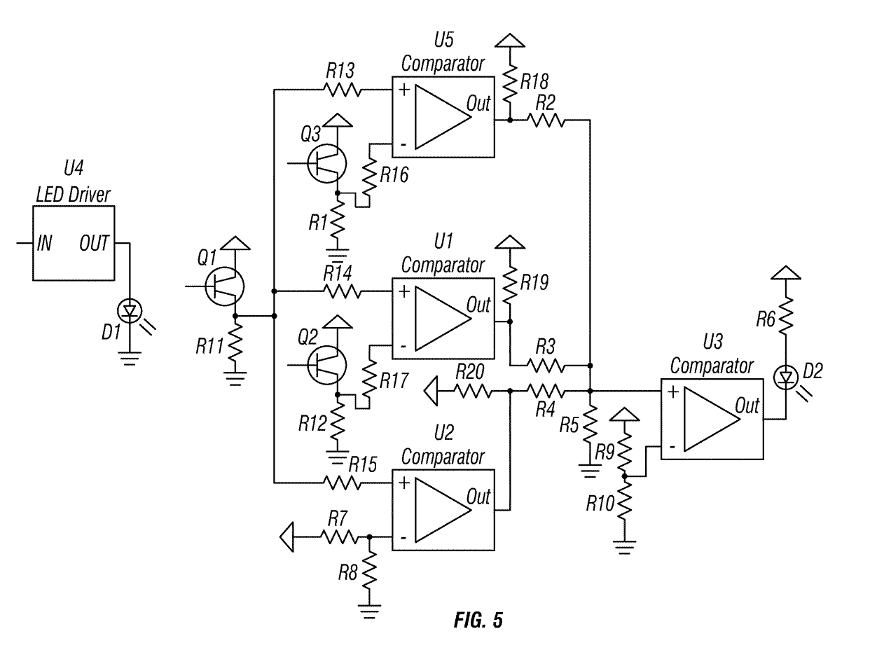

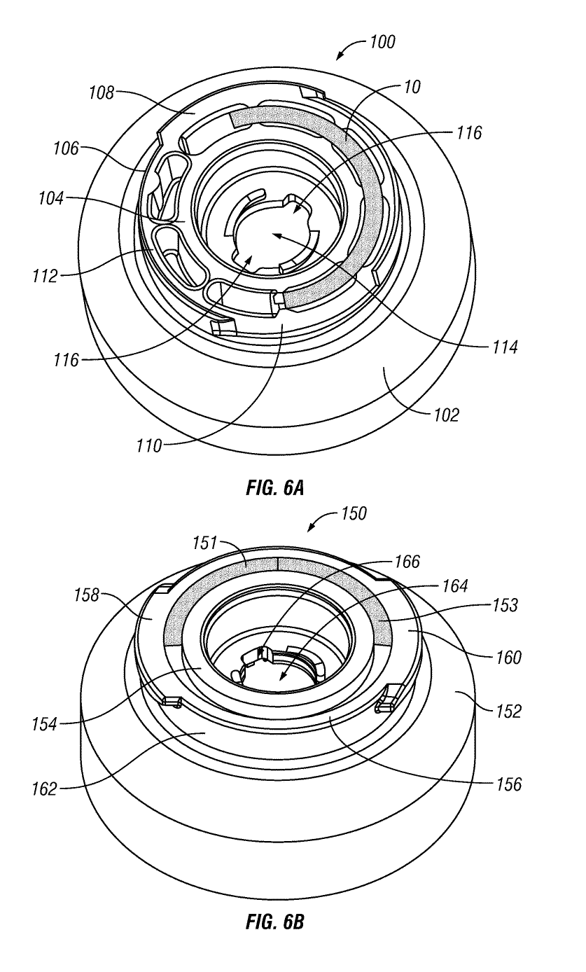

FIG. 5 is an electrical schematic for implementing logic control by the light intensity ratio. U4 provides an LED driver circuit for an LED light source. In this example, there are three light sensors (Q1, Q2, and Q3) and four comparators (U1, U2, U3, and U5). Q1 is the center light sensor (corresponding to 60a in FIG. 1B). Q2 and Q3 are on either side of Q1 (corresponding to 60b and 60c in FIG. 1B) and are designated “edge” sensors. Depending on which way the filter is installed into the manifold, Q2, or Q3 will be properly positioned over the light guide edge to collect the refracted light from output face 16, whose amplitude is in a known ratio to that impinging on Q1—for light guides that are the correct design by having the input and output faces sloped at a known angle Theta, such as the exemplified 45 degree angle, and dependent on the refractive index of the light guide material as shown in FIG. 3. Comparators U1 and U5 are both connected to the output of Q1 (central sensor). Only one of the edge sensors is connected to each of these two comparators. The ratio of light intensity between the center and edge light sensors is determined by setting the gain of each sensor differently (R1 or R12) than that of Q1(R11). If an edge sensor senses light intensity from a light guide with the wrong refractive index or a light guide without the correct angle for the sloping input or output faces, the output into the comparator will not match the correct level and prevent the output from turning on. Thus, changing the angle Theta can be used as another way to authentic different cartridges since the output ratio, for a given material, will vary as the angle is changed. For a case when the LED light is blocked in an attempt to defeat the optical lock, comparator U2 sets a minimum threshold and compares that to Q1 output and prevents turn-on if this threshold level is not met. This also could be used to detect a burnt-out LED. Comparator U3 sums the outputs from U1, U5, and U4. If both U1 or U5 and U2 are at valid output levels, U3 will turn on the output.

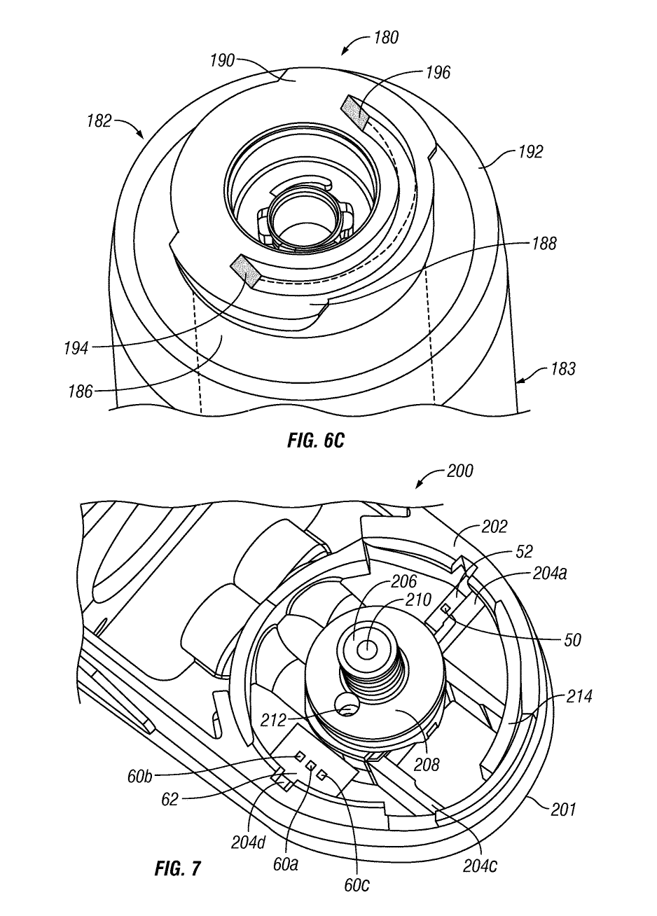

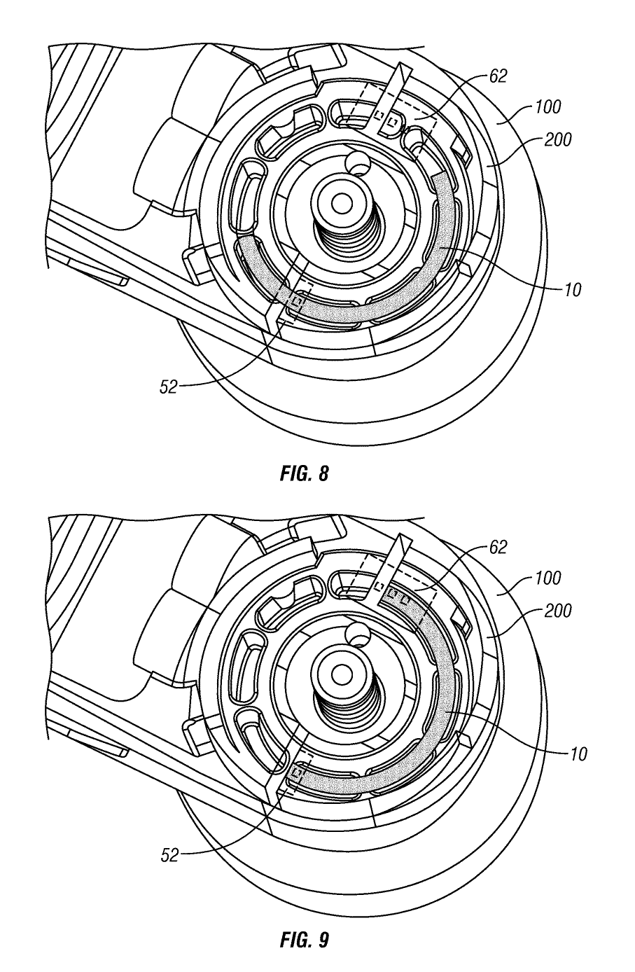

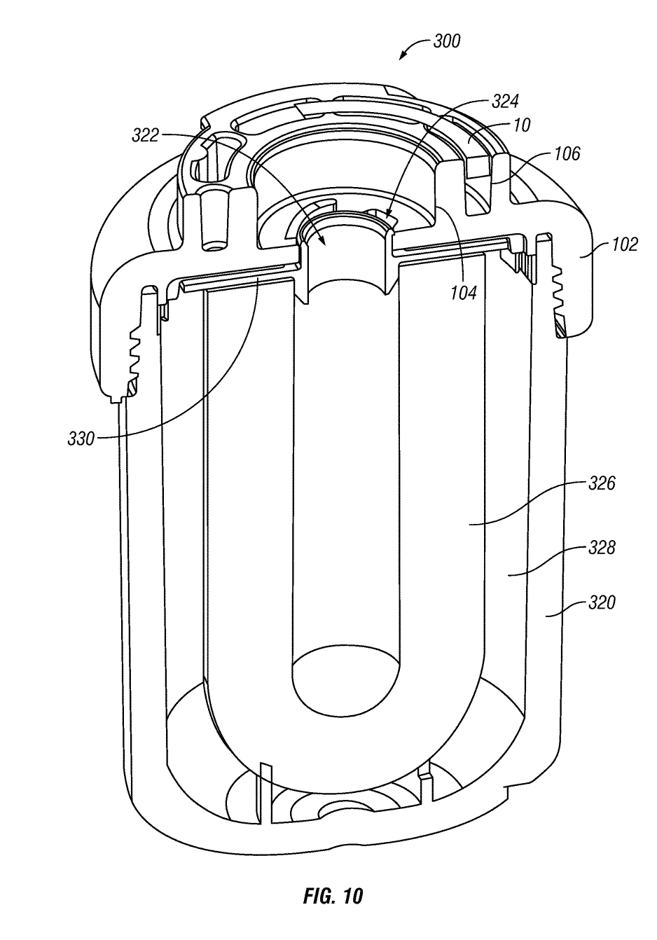

FIG. 6A is an exemplary keyed filter element or component comprising an optical key. Specifically, FIG. 6A provides a keyed filter element 100 in the form of a filter cap 102 that is suitable to form a housing with a body or sump. The filter cap has a neck portion 112 that has a generally narrower diameter relative to the portion of the filter cap that attaches to the body or sump. The filter cap also includes a pair of opposed ears or tabs 108 and 110 to engage with opposed corresponding ramps (e.g., FIG. 7 item 214) in the manifold that axially move and hold the filter in the manifold as it is rotated into position. The filter cap defines a central opening 114 and one or more slots 116 (i.e., 2 or 4 or even 6 slots). The central opening 114 is designed to receive an end cap affixed to a filter media or to receive a filter media directly. Slots 116 in combination with surfaces of the filter cap or filter media then correspond to an inlet opening (e.g., FIG. 10 item 324).

Light guide 10 is installed into a recess between the inner and outer bores, 104 and 106 respectively, formed in the neck portion 112 of the filter cap 102. For this embodiment, the light guide 10 is generally an arch spanning about 180 degrees, with a width, w, and having substantially planar first and second sides (18, 20 as shown in FIG. 1A) separated by a thickness, t. At each end of the arch, the input and output faces are sloped by an angle Theta, θ, of approximately 45 degrees. In other embodiments, the light guide's geometry can be significantly different and often is derived from the geometry of the filter it is being adapted to.

FIG. 6B is an exemplary keyed filter element or component comprising an optical key made from two types of materials. Specifically, FIG. 6B provides a keyed filter element 150 in the form of a filter cap 152 that is suitable to form a housing with a body or sump. The filter cap has a neck portion 162 that has a generally narrower diameter relative to the portion of the filter cap that attaches to the body or sump. The filter cap also includes a pair of opposed ears or tabs 158 and 160 to engage with opposed corresponding ramps (e.g., FIG. 7 item 214) in the manifold that axially move and hold the filter in the manifold as it is rotated into position.

In this embodiment the light guide comprises two portions in combination: 160 and 161, which are installed into a recess between the inner and outer bores, 164 and 166 respectively, formed in the neck portion 112 of the filter cap 102. The two potions 160 and 161 may be the same or different materials so long as they are in communication to propagate light from one to the other. Each portion 160 and 161 is generally an arch spanning about 90 degrees, with a width, w, and having substantially planar first and second sides (18, 20 as shown in FIG. 1A) separated by a thickness, t, At each end of each arch, the input and output faces are sloped by an angle Theta, θ, of approximately 45 degrees. The filter cap defines a central opening 164 and one or more slots 166 (i.e., 2 or 4 or even 6 slots). The central opening 164 is designed to receive an end cap affixed to a filter media or to receive a filter media directly. Slot(s) 166 in combination with surfaces of the filter cap or filter media then correspond to an inlet opening (e.g., FIG. 10 item 324).

FIG. 6C is an exemplary keyed filter element or component that is also an optical key. Specifically, FIG. 6C provides a filter element 180 in the form of a filter cap 182 that is suitable to form a housing with a body or sump 183. The filter cap 182 is made from a transparent or semi-transparent solid material that propagates light in a non-linear path between two points using the process of internal reflection. The filter cap 182 comprises a body 192, an input face 194, and an output face 196. The filter cap 182 also includes a pair of opposed ears or tabs 188 and 190 to engage with opposed corresponding ramps (e.g., FIG. 7 item 214) in the manifold that axially move and hold the filter in the manifold as it is rotated into position. In this embodiment, light from the light source is received by the input face 194, propagates through the body 192 of the filter cap 182 and is emitted by output face 196 to a light detector in the manifold. Filter media 186 located in sump 183 can be seen through the transparent filter cap (or cover) 182.

FIG. 7 is an exemplary filter manifold comprising an optical lock. Filter manifold 200 comprises a manifold body 201, which comprises a frame 202 and a plurality of braces 204a, 204b, 204c, and 204d. A first circuit board 52 holding light source 50 is located on brace 204a. A second circuit board 62 holding light sensors 60a, 60b, and 60c is located on brace 204d. In other embodiments, the light source and detector may be placed onto a single circuit board. In yet other embodiments, the circuit board may be an annulus with multiple light sources and detectors that receive or transmit light to or from the corresponding optical key.

An inlet boss 206 for mating with a filter cartridge having a corresponding recess comprises a first face and a first outer diameter about a longitudinal axis, at least one annular seal circumscribing the inlet boss, and a discharge opening 212 in fluid communication with the manifold inlet port located in the first face. An outlet cylindrical projection 208 depending from the inlet boss 206 comprises a second face and a second outer diameter about the longitudinal axis, the second outer diameter being is smaller than the first outer diameter of the inlet boss 206; at least one annular seal circumscribing the outlet cylindrical projection 208 and an outflow opening 210 in fluid communication with the manifold outlet port located in the second face.

FIG. 8 shows a schematic of the filter element 100 of FIG. 6 partially rotated into the manifold 200 of FIG. 7. In FIG. 8, the light guide 10 is not in position relative to the light source on first circuit board 52 or to the detectors on second circuit board 62. The optical circuit is not complete in FIG. 8. FIG. 9 shows a schematic of the filter element 100 of FIG. 6 fully installed into the manifold 200 of FIG. 7 to complete an optical circuit, where the light guide 10 is properly positioned relative to the light source on first circuit board 52 and to the detectors on second circuit board 62.

FIG. 10 shows a cross-section of an exemplary filter or filter cartridge 300 comprising a filter cap 102 and a sump 320. An inlet opening 324 receives a fluid such as water from a manifold, for example from the discharge opening 212 of FIG. 7 and flows into the media chamber 328 and the water contacts filter media 326 for treatment/purification. An exemplary filter media is a carbon block with polymeric binder particles. Water flows through the filter media 326 and through outlet opening 322 back to a manifold, for example through the outflow opening 210 of FIG. 7. The outlet opening 322 is defined by end cap 330, which is glued in this embodiment to filter media 326.

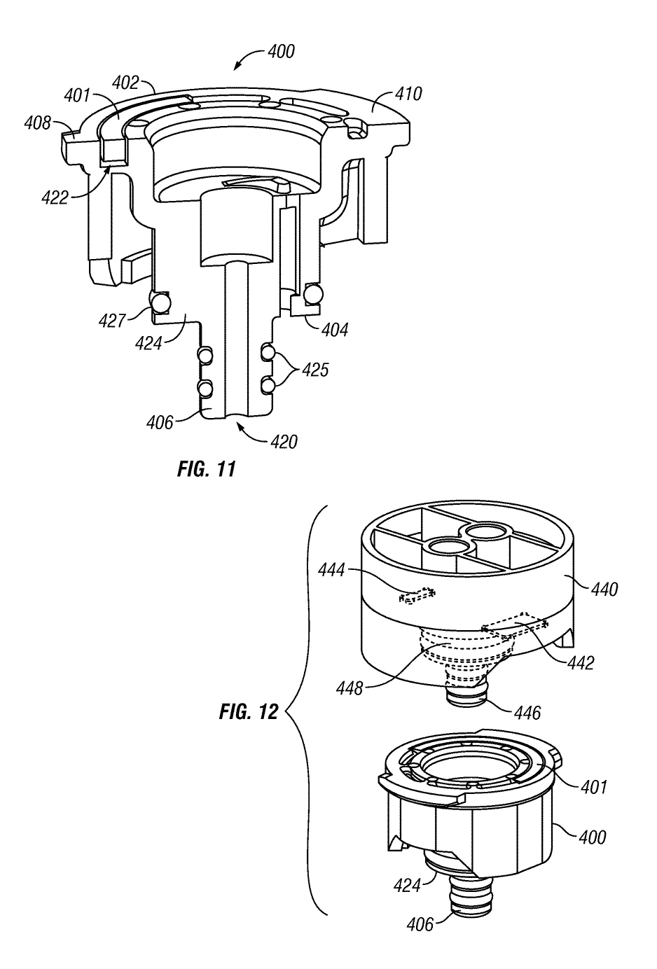

FIG. 11 shows a schematic of a keyed adapter 400 that may be used to associate an optical key with an existing fluid filter element or component. The adapter 400 is a fluid-handling device that receives water or fluid from a source such as a water manifold and directs it to a filter element such as a fluid filter. Adapter 400 comprises a manifold end 402 and a filter end 404. The adapter 400 is designed to engage with a fluid filter manifold having an optical lock such as that shown in FIG. 7. The adapter 400 is also designed to operatively accept a filter element or structure such as that shown in FIGS. 6A and 6B or to receive a filter media directly. Manifold end 402 can substantially resemble a filter cap (e.g., FIG. 6A item 102 or FIG. 6B item 152) while filter end 404 can substantially resemble an outlet cylindrical projection (e.g., FIG. 7 item 208). Filter end 404 can comprise an outlet cylindrical projection 424 an inlet boss 406 such that filter end 404 is operatively connectable to filter element or media. O-rings 425 provide a seal upon assembly of the adapter 400 into the filter element or media. The inlet boss 406 defines an outflow opening 420. Manifold end 402 can comprise, for example, a pair of tabs or ears 408 and 410, such that manifold end 402 is operatively connectable to a manifold assembly (e.g., FIG. 7 item 200). Manifold end defines a central opening and one or more slots to permit fluid flow into and out of the filter element or structure. Manifold end 402 can be designed such that the adapter 400 remains permanently operatively connected to a manifold assembly. Or, the adapter 400 may be designed such that removal of the adapter 400 from a manifold assembly requires significantly excess torque as compared to removal of filter media from the filter end 404 such that adapter 400 need only be attached to a manifold assembly one time. O-ring 427 provides a seal upon assembly of the adapter 400 into a filter element. Light guide 401 is located in a recess 422 of the adapter 400. The light guide 401 may be one portion or multiple portions. The light guide 401 is attached to the adapter as desired. For example, the light guide may be integrally formed with the body, overmolded with the body, or removable relative to the body.

FIG. 12 shows a schematic of the exemplary adapter 400 of FIG. 11 and a manifold 440 in an expanded view, where the adapter 400 comprises the light guide 401. The adapter 400 receives the inlet boss 446 and outlet cylindrical projection 448 of the manifold 440 upon assembly. When the light guide 401 is fully installed in the proper position, light from a light source on first circuit board 444 is propagated to detectors on second circuit board 442 to complete the circuit.

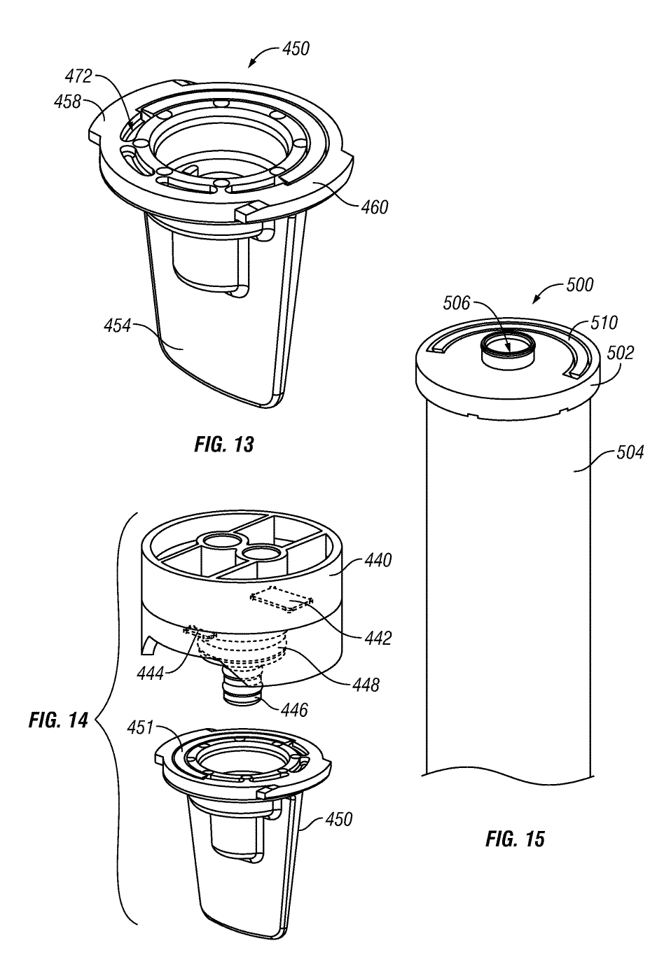

FIG. 13 shows a schematic view of a keyed bypass (also referred to as a bypass cap) 450 that may be used to provide an optical key to a manifold with an optical lock. The bypass 450 is a fluid-handling device that receives water or fluid from a source such as a water manifold and directs the water and fluid directly back to the manifold. A bypass does not typically provide any kind of treatment and/or purification to the water or fluid. Bypass 450 comprises a manifold end 452. The bypass 450 is designed to engage with a fluid filter manifold comprising an optical lock such as that shown in FIG. 7. Manifold end 452 can substantially resemble a filter cap (e.g., FIG. 6A item 102 or FIG. 6B item 152). Manifold end 452 can comprise, for example, a pair of tabs or ears 458 and 460, such that manifold end 452 is operatively connectable to a manifold assembly (e.g., FIG. 7 item 200). Manifold end 452 can be designed such that the bypass 450 remains permanently operatively connected to a manifold assembly. The end opposite the manifold end 454 may be designed in any shape or configuration that accommodates any manifold assembly of interest. Light guide 451 is located in a recess 472 of the bypass 450. The light guide 401 may be one portion or multiple portions. The light guide 451 is attached to the bypass as desired. For example, the light guide may be integrally formed with the body, overmolded with the body, or removable relative to the body.

FIG. 14 shows a schematic of the exemplary bypass 450 of FIG. 13 and a manifold 440 in an expanded view, where the bypass 450 comprises the light guide 451.

The bypass 450 receives the inlet boss 446 and outlet cylindrical projection 448 of the manifold 440 upon assembly. When the light guide 451 is fully installed in the proper position, light from a light source on first circuit board 444 is propagated to detectors on second circuit board 442 to complete the circuit.

FIG. 15 is an exemplary filter element comprising an optical key.

Specifically, FIG. 15 provides a keyed filter element 500 in the form of an end cap 502 that is affixed to a filter media 504. The end cap 502 defines an outlet opening 506. Light guide 510 is attached to the end cap 502 to form a keyed filter element. Light guide 510 may be located in a grove of end cap 502, or it may be located on a surface of the end cap 502. The light guide 510 may be one portion or multiple portions. The light guide 451 is attached to the end cap as desired. For example, the light guide may be integrally formed with the end cap, overmolded with the end cap, or removable relative to the end cap.

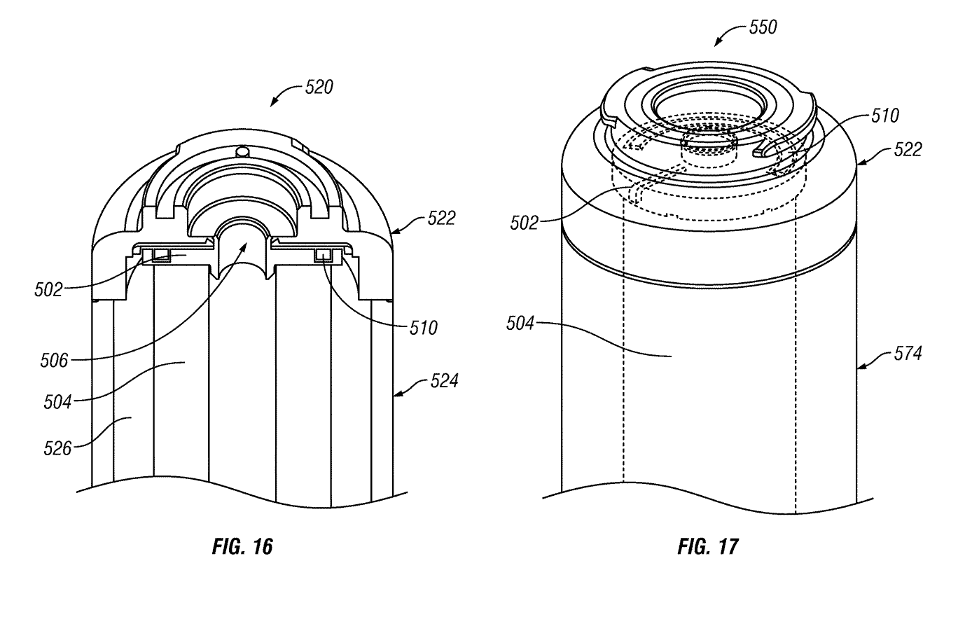

In FIG. 16, keyed filter element 500 of FIG. 15 is placed in a housing comprising a transparent cover 522 and a sump 524 to form a filter cartridge 520. Inlet opening 506 receives a fluid such as water from a manifold, for example from the discharge opening 212 of FIG. 7 and flows into the media chamber 526 and the water contacts filter media 504 for treatment/purification. An exemplary filter media is a carbon block with polymeric binder particles. Water flows through the filter media 504 and through outlet opening 506 back to a manifold, for example through the outflow opening 210 of FIG. 7. The outlet opening 506 is defined by end cap 502, which is glued in this embodiment to filter media 504. Light guide 510 receives light from a light source through transparent cover 522, which is propagated to detectors of the manifold to complete the circuit.

In FIG. 17, filter cartridge 550 comprises the keyed filter element 500 of FIG. 15 in a housing that comprises a transparent cover 522 and a transparent sump 574.

Light guide 510 associated with end cap 502 receives light from a light source through transparent cap 522 and/or transparent sump 574, which is propagated to detectors of the manifold to complete the circuit.

### EXAMPLE

A filter cap in accordance with FIG. 6A was made for use with a filter media and a sump to form a filter element. The light guide was made in accordance with FIGS. 1A-1B from polyvinylidenefluoride (PVDF). The filter element was installed in a manifold in accordance with FIG. 7 as shown in FIGS. 8 and 9. When the light guide was properly positioned relative to the light source on first circuit board and to the detectors on second circuit board, the light guide was effective to propagate light from the light source to the input face through the arcuate shape to the output face to the light detectors.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. A keyed fluid-handling device comprising:
a fluid-handling device; and
an optical key associated with a portion of the fluid-handling device, the optical key providing a non-linear path for light.

2. The keyed fluid-handling device of claim 1, wherein the fluid-handling device comprises a filter, a bypass, or an adapter, which is engagable with a water manifold.

3. The keyed fluid-handling device of claim 1, wherein the fluid-handling device comprises an inlet opening defined by a portion of the device.

4. The keyed fluid-handling device of claim 2, wherein the fluid-handling device comprises a filter that comprises:
a filter media; and
optionally: an end cap affixed to the filter media, a housing enclosing the filter media, or both;
wherein the optical key is attached to a portion of the filter media or to a portion of the optional end cap or housing.

5. The keyed fluid-handling device of claim 1, wherein the optical key comprises a light conduit that is arcuate.

6. The keyed fluid-handling device of claim 1, wherein the optical key comprises one or more of: glass, a thermoset plastic, and a thermoplastic.

7. The keyed fluid-handling device of claim 1, wherein the optical key comprises one or more polymers selected from the group consisting of: polyvinylidenefluoride (PVDF), poly(methyl methacrylate) (PMMA), poly-fluoroalkyl methacrylates, urethanes, and polycarbonate.

8. The keyed fluid-handling device of claim 1, wherein the optical key comprises a transparent filter cap that comprises a body, an input face, and an output face.

9. A fluid filter cartridge comprising:
a filter media;
a housing enclosing the filter media, the housing having inlet and outlet openings in fluid communication with the filter media; and
a light guide that is attached to a portion of the filter cartridge.

10. The fluid filter cartridge of claim 9, wherein the light guide is attached to the housing.

11. The fluid filter cartridge of claim 9, wherein the light guide is attached to a neck portion of the housing.

12. The fluid filter cartridge of claim 9, wherein the light guide comprises glass or a polymer selected from the group consisting of: polyvinylidenefluoride (PVDF), poly(methyl methacrylate) (PMMA), poly-fluoroalkyl methacrylates, urethanes, and polycarbonate.

13. The fluid filter cartridge of claim 9, wherein the light guide comprises one or more light extraction elements.

14. The fluid filter cartridge of claim 9, wherein the light guide comprises an arcuate shape.

15. The fluid filter cartridge of claim 9, wherein the light guide comprises an input face and an output face.

16. The fluid filter cartridge of claim 9, wherein the input face, the output face, or both comprise a surface having a face angle θ in the range of 1° to 90°.

17. The fluid filter cartridge of claim 16, wherein the face angle θ is in the range of 30° to 60°.

18. The fluid filter cartridge of claim 9, wherein a refractive index of the light guide is from 1.30 to 1.75.

19. The fluid filter cartridge of claim 18, wherein the refractive index is from 1.35 to 1.45.

20. The fluid filter cartridge of claim 18, wherein the refractive index is from 1.45 to 1.55.

21. The fluid filter cartridge of claim 18, wherein the refractive index is from 1.55 to 1.65.

22. The fluid filter cartridge of claim 9, wherein the light guide comprises an arch

23. The fluid filter cartridge of claim 22, wherein the arch spans 150-210 degrees.

24. The fluid filter cartridge of claim 23, wherein the light guide further comprises two or more light extraction elements along the arch.

25. A fluid filter manifold comprising:
a manifold body;
a manifold inlet port and a manifold outlet port;
a fluid supply valve; and
an optical lock located on the manifold body comprising a light source and a light sensor.

26. The fluid filter manifold of claim 25, wherein the fluid supply valve is operatively connected to the optical lock that comprises:
a first state wherein the light sensor detects light from the source; and
a second state wherein the light sensor does not detect light from the light source.

27. The fluid filter manifold of claim 25, wherein the light sensor cannot detect light from the light source unless an optical key is present to deliver the light from the light source to the light sensor.

28. The fluid filter manifold of claim 25 wherein the manifold body comprises:
a frame;
one or more braces connected to the frame;
an inlet boss comprising a first face and a first outer diameter about a longitudinal axis; a first annular seal circumscribing the inlet boss; a discharge opening in fluid communication with the manifold inlet port located in the first face; and
an outlet cylindrical projection depending from the inlet boss comprising a second face and a second outer diameter about the longitudinal axis, the second outer diameter being is smaller than the first outer diameter of the inlet boss; a second annular seal circumscribing the outlet cylindrical projection and an outlet opening in fluid communication with the manifold outlet port located in the second face.

29. The fluid filter manifold of claim 25, wherein the light source is located on a first brace and the light sensor is located on a second brace.

30. The fluid filter manifold of claim 25, wherein the light source is located 180 degrees away from the light sensor.

31. A water treatment system comprising:
the fluid filter manifold of claim 25; and
a keyed fluid-handling device comprising a fluid-handling device and an optical key.

32. A water treatment system comprising:
the fluid filter cartridge of claim 9; and
a fluid filter manifold comprising an optical lock.

33. A method of treating water comprising:
obtaining the fluid filter manifold of claim 25;
operatively connecting a fluid filter element comprising an optical key to the fluid filter manifold; and
supplying water to the fluid filter manifold.

34. A method of treating water comprising:
obtaining the fluid filter cartridge of claim 9;
operatively connecting the fluid filter cartridge to a fluid filter manifold comprising an optical lock to the fluid filter manifold; and
supplying water to the fluid filter manifold.
